(19) United States
(12) Patent Application Publication
(10) Pub. No.: US 2025/0047053 A1
(43) Pub. Date: Feb. 6, 2025

(54) LIQUID-COOLED LASER AMPLIFIER HEAD

(71) Applicants: CENTRE NATIONAL DE LA RECHERCHE SCIENTIFIQUE, PARIS (FR); UNIVERSITE DE BORDEAUX, BORDEAUX (FR); COMMISSARIAT A L'ENERGIE ATOMIQUE ET AUX ENERGIES ALTERNATIVES, PARIS (FR)

(72) Inventors: Denis MARION, PESSAC (FR); Christophe FERAL, MARTIGNAS SUR JALLE (FR); Jérôme LHERMITE, ANGLET (FR); Philippe BALCOU, TALENCE (FR)

(73) Assignees: CENTRE NATIONAL DE LA RECHERCHE SCIENTIFIQUE, PARIS (FR); UNIVERSITE DE BORDEAUX, BORDEAUX (FR); COMMISSARIAT A L'ENERGIE ATOMIQUE ET AUX ENERGIES ALTERNATIVES, PARIS (FR)

(21) Appl. No.: 18/721,864

(22) PCT Filed: Dec. 9, 2022
(86) PCT No.: PCT/EP2022/085134

§ 371 Date: Jun. 20, 2024

(30) Foreign Application Priority Data
Dec. 20, 2021 (FR) FR2114018

(51) Int. Cl. H01S 3/04; H01S 3/042

(52) U.S. Cl. CPC H01S 3/0407; H01S 3/042

(57) ABSTRACT

A laser amplifier head including plates of a laser active medium which are placed inside a housing which has an inlet port and an outlet port. A cooler includes a cooling circuit connected to the housing and suited to the circulation of a cooling liquid, a cooling duct, inside the housing, in contact with the active medium, in which the cooling liquid flows, allowing an exchange of heat between the latter and the plates, and a regulator able to regulate a temperature of the cooling liquid such that a thermo-optical coefficient

$$\frac{dn}{dT}$$

of the cooling liquid satisfies the following condition:

$$\vert \frac{d n}{d T} \vert < \frac{6 {λ}_{0}}{Δ T * \sum {φ}_{H}} ( I )$$

where ΔT represents the difference in temperature between the cooling liquid and the plates of the active medium, Σφ_{H} represents the sum of the hydraulic diameters of the cooling duct and λ₀ represents the wavelength of the beam in a vacuum.

### FIELD

The invention relates to a solid-state laser amplifier head for use at high power (average power of the order of 1 kW or more, pulses of the order of 1 J or more). The laser head of the invention is particularly suited to the production of a multi-pass laser amplifier, but can also be placed inside an optical cavity to produce a regenerative amplifier.

### BACKGROUND

When designing a solid-state laser amplifier, especially one intended to operate at high power levels, the cooling of the active medium is of particular importance. In fact, excessive temperature adversely affects the amplification capacity as well as the optical quality of the laser beam (thermal lensing, deformation of the active medium) and polarization thereof (stress-induced birefringence), and can even lead to degradation or rupture of the active medium.

The active medium is known to be shaped in the form of a plate or disk, typically with a thickness of less than—or even much less than—one tenth of its lateral dimensions. Cooling can be achieved in several ways:
By the mount, connected to an internal cooling circuit.
By the reflective rear surface, which requires very thin thicknesses of active medium (typically 300 micrometers), and therefore a high number (typically 12 or more) of passes. This is known as “thin disk” technology or “active mirror” technology for greater thicknesses.
By an incident fluid on the main surfaces of the disk in laminar flow; this fluid is most often a gas, but can sometimes be a liquid. For example, the paper entitled “Fully immersed liquid cooling thin-disk oscillator” (NIE, R. Z., SHE, J. B., ZHAO, P. F., et al. Laser Physics Letters, 2014, vol. 11, no. 11, p. 115808) describes a laser oscillator whose active medium is formed of two thin Nd:YAG plates tilted to Brewster's angle relative to the optical path of the laser beam and forming an angle therebetween, immersed in a flow of cooling liquid. The papers “3 kW liquid-cooled elastically-supported Nd:YAG multi-slab CW laser resonator” (F U, Xing, L I, Peilin, L I U, Qiang, et al. Optics express, 2014, vol. 22, no. 15, pp. 18421-18432) and “7 kW direct-liquid-cooled side-pumped Nd:YAG multi-disk laser resonator” (WANG, Ke, TU, Bo, JIA, Chunyan, et al. Optics Express, 2016, vol. 24, no. 13, pp. 15012-15020) describe laser oscillators whose active medium is formed by a stack of millimeter-thick disks, with a cooling liquid (D₂O) circulating in the spaces between the disks.

It is also known to rotate an active medium of large dimensions relative to the diameter of the laser beam, with the laser beam eccentric to the axis of rotation. Heat is then stored in a larger volume and exchanged over a larger surface area, thus greatly attenuating the thermal effects.

### SUMMARY

The aim of the invention is to provide a laser amplifier head with more efficient cooling than in the prior art, thus enabling a higher power level to be achieved, without degrading the optical quality of the laser beam.

In accordance with the invention, improved cooling is achieved by using a cooling liquid in turbulent flow. In fact, it is well known that a fluid in turbulent flow in contact with a wall has a much higher heat exchange coefficient than a laminar flow of the same fluid. Conventionally, these flows are avoided as they severely degrade the spatial properties of the laser beam. In accordance with the invention, this adverse effect is avoided or at least minimized by maintaining the cooling liquid at a temperature such that its thermo-optical coefficient is close to zero. Thus, temperature fluctuations within the turbulent flow do not result in optical index fluctuations that could influence the propagation of the beam to be amplified. In the case of water at ambient pressure, for example, the thermo-optical coefficient cancels out at around 0° C.

To this end, the invention relates to a laser amplifier head comprising at least one plate of a solid-state laser active medium which is placed inside a housing which has an inlet port and an outlet port for a cooling liquid, as well as at least one window that allows a laser beam to be amplified to pass through the plate or plates of laser active medium, characterized in that it also comprises:
a cooling means for the active medium, the cooling means comprising a cooling circuit connected to the housing via the inlet port and the outlet port, the cooling circuit being suited to the circulation of a cooling liquid, the cooling means comprising at least one cooling duct, inside the housing, connecting the inlet port and the outlet port, and in contact with the active medium, wherein the cooling liquid flows so as to allow an exchange of heat between the active medium and the cooling liquid, the cooling means also comprising a regulating means able to regulate a temperature of the cooling liquid such that a thermo-optical coefficient

$$\frac{d n}{d T}$$

of the cooling liquid satisfies the following condition:

$$\vert \frac{d n}{d T} \vert < \frac{6 {λ}_{0}}{Δ T * \sum {φ}_{H}} ( I )$$

And preferably

$$\vert \frac{d n}{d T} \vert < \frac{6 {λ}_{0}}{Δ T * \sum {φ}_{H}} ( I )$$

wherein ΔT represents the difference in temperature between the cooling liquid and the at least one plate of the active medium, Σφ_{H} represents the sum of the hydraulic diameters of the cooling ducts through which the laser beam passes and Δ₀ the wavelength of the laser beam in a vacuum.

According to one aspect of the invention, the cooling liquid regulating means is able to cancel the thermo-optical coefficient of the cooling liquid.

According to one aspect of the invention, the cooling means comprises a cooling liquid flow rate regulating means able to regulate a Reynolds number of the cooling liquid so as to be greater than 2300.

According to one aspect of the invention, the cooling liquid is water.

According to one aspect of the invention, the cooling liquid is a mixture of at least two chemical substances and has a thermo-optical coefficient different from that of each of these at least two substances.

According to one aspect of the invention, the cooling liquid temperature regulating means is able to regulate the cooling liquid temperature between 0° C. and 10° C.

According to one aspect of the invention, the cooling means comprises:
a cooling liquid storage device, said cooling liquid being in equilibrium between its liquid and solid phases,
a cooling liquid pumping device able to draw up the liquid phase of the cooling liquid from the storage device.

According to one aspect of the invention, the cooling liquid is in contact with one of the plurality of active medium plates.

According to one aspect of the invention, the laser amplifier head comprises a contact opening, a hygroscopic insulating volume and an eccentric opening, the contact opening having a face bearing against the housing, the contact opening, the hygroscopic insulating volume and the eccentric opening being successively aligned along the laser flow.

According to one aspect of the invention, the laser amplifier head comprises at least one sensor positioned along the cooling circuit so as to measure the flow rate and/or the temperature of the cooling liquid in order to deduce the Reynolds number of the cooling liquid in the at least one cooling duct inside the housing.

According to one aspect of the invention, the laser amplifier head comprises a system for physico-chemical filtering and biological purification of the cooling liquid.

According to one aspect of the invention, the laser amplifier head comprises a system for verifying the spatial quality of an amplified laser beam at the outlet of the laser amplifier head.

### BRIEF DESCRIPTION OF THE FIGURES

The invention will be better understood and further advantages will become apparent upon reading the detailed description of an exemplary embodiment, shown by the accompanying drawing wherein:

FIG. 1 shows a schematic view of a laser amplifier head according to the invention;

FIG. 2 shows a schematic view of the laser amplifier head in one embodiment;

FIG. 3 shows a graph of the spatial frequency distribution of a beam that has passed through an amplifier head in turbulent regime according to the prior art;

FIG. 4 shows a graph of the spatial frequency distribution of a beam that has passed through an amplifier head in turbulent regime according to the invention;

FIG. 5A is a strioscopic image acquired by an optical sensor of an amplified laser beam that has passed through a cooling liquid in turbulent regime at a temperature of 20° C.;

FIG. 5B is a strioscopic image acquired by an optical sensor of an amplified laser beam that has passed through a cooling liquid in turbulent regime at a temperature of 15° C.;

FIG. 5C is a strioscopic image acquired by an optical sensor of an amplified laser beam that has passed through a cooling liquid in turbulent regime at a temperature of 10° C.;

FIG. 5D is a strioscopic image acquired by an optical sensor of an amplified laser beam that has passed through a cooling liquid in turbulent regime at a temperature of 5° C.;

FIG. 5E is a strioscopic image taken by an optical sensor of an amplified laser beam that has passed through a cooling liquid in turbulent regime at a temperature of 1° C.;

FIG. 6 shows the angular distribution in a plane transverse to the laser beam axis, of the energy scattered outside the angle covered by the laser beam, after passing through a turbulent flow at different temperatures.

For the sake of clarity, the same components will have the same references in the various figures.

### DETAILED DESCRIPTION

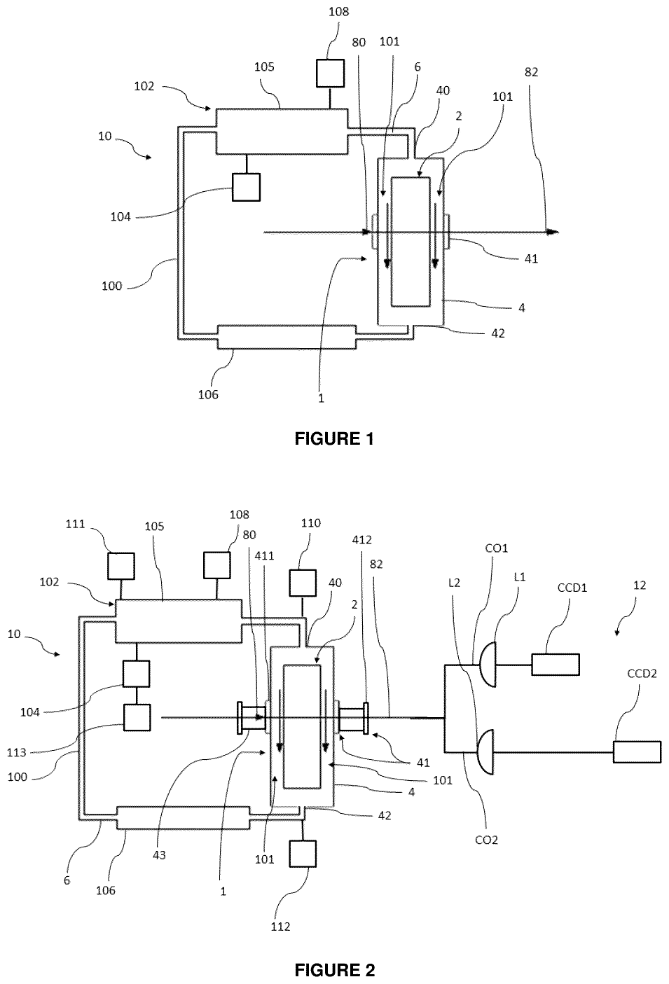

FIG. 1 is a schematic view of a laser amplifier head 1 according to the invention. The laser amplifier head 1 comprises at least one plate of a solid-state laser active medium 2 placed inside a housing 4. The active medium 2 is preferentially made up of a plurality of plates, more precisely disks of yttrium aluminum garnet (YAG) doped with ytterbium (Yb:YAG). The incident laser beam 80 and the amplified laser beam, representing the incident laser beam 80 after the latter has passed through the active medium 2, enter and exit the housing 4 through windows or opening 41, pass through at least one plate of the active medium 2. The laser amplifier head 1 also comprises a longitudinal optical pumping system (not shown) for amplifying the incident laser beam 80, which then becomes an amplified laser beam 82 upon exiting the housing 4.

As previously stated, the amplification of the incident beam 80, as it passes through the active medium 2 and due to the action of auxiliary laser beams bringing energy into the active medium plate 2, a process referred to as “optical pumping”, generates a large amount of heat to be dissipated.

To this end, the housing 4 is provided with an inlet port 40 and an outlet port 42 for a cooling liquid 6.

The laser amplifier head 1 also comprises cooling means 10 for the active medium 2. The cooling means 10 comprises a cooling circuit 100 connected to the housing 4 via the inlet port 40 and outlet port 42 and is designed for circulating a cooling liquid 6 so as to allow an exchange of heat between the active medium 2 and the cooling liquid 6. To this end, the cooling means 10 comprises at least one cooling duct 101 inside the housing 4, connecting the inlet port 40 and the outlet port 42, and in contact with the active medium 2, wherein the cooling liquid flows, so as to allow the transition of the cooling liquid 6 along the at least one plate of the active medium 2 thus allowing an exchange of heat between the active medium 2 and the cooling liquid 6. This at least one cooling duct 101 is thus defined by a hydraulic diameter cpH. In addition, the cooling means 10 comprises a means 102 of regulating the temperature of the cooling liquid 6 able to regulate a temperature of the cooling liquid 6 such that a thermo-optical coefficient

$$\frac{d n}{d T}$$

of the cooling liquid 6 satisfies the following condition:

$$\vert \frac{d n}{d T} \vert < \frac{6 {λ}_{0}}{Δ T * \sum {φ}_{H}} ( I )$$

Wherein ΔT represents the difference in temperature between the cooling liquid 6 and the at least one plate of the active medium 2, and more precisely, the maximum temperature difference with the surface area of the plate, of the at least one plate of the active medium 2, exposed to the cooling liquid 6, Σφ_{H} represents the sum of the hydraulic diameters φ_{H} of the cooling ducts 101 through which laser beam passes, and λ₀ represents the wavelength of the laser beam 80 in a vacuum. The number of times each cooling duct 101 is passed through must be taken into account as a weight term in the sum Σφ_{H} of the hydraulic diameters φ_{H}. In fact, the incident laser beam 80 can pass through several cooling ducts 101, as shown in FIG. 1, in a so-called straight configuration, or twice through the same cooling duct 101, in a “round trip”, in an active mirror configuration. Furthermore, the temperature distribution in the at least one active medium plate 2 is not homogeneous, with the center of the at least one active medium plate 2, namely its core, being significantly hotter than the periphery.

Indeed, it can be considered that a maximum fluctuation in the refractive index Δn between two points of the cooling liquid 6 can be defined by the formula

$$\vert \frac{d n}{d T} \vert * Δ T$$

and can occur over a spatial turbulence scale L proportional to the hydraulic diameter φ_{H} of the cooling liquid 6. As an indicative example,

$$L = \frac{{φ}_{H}}{12} .$$

This maximum fluctuation in the refractive index Δn then induces a local variation in the optical path Δn*L which is desired to be much less than the wavelength of light defined by λ₀ according to a factor called alpha, which is equal, as an indicative example, to the value of 8.

The thermo-optical coefficient

$$\vert \frac{dn}{dT} \vert$$

is defined as the derivative of the optical index of the cooling liquid with respect to the temperature of the cooling liquid 6. In practice, the thermo-optical coefficient defines the ability of the liquid to deform a light beam passing through therethrough as a function of parameters such as the temperature or Reynolds number thereof. Thus, ideally, the thermo-optical coefficient

$$\frac{dn}{dT}$$

of the cooling liquid 6 should be zero, so as not to distort the light beam passing through therethrough. Nevertheless, condition C1 is sufficient to greatly reduce this deformation of the light beam.

Thus, the cooling means 10 comprises a means of regulating the flow rate 104 of the cooling liquid 6 able to regulate a Reynolds number of the cooling liquid 6 so as to be greater than 2300. As a result, the cooling liquid 6 flows in the cooling circuit 100, and particularly in the housing 4 and in the at least one cooling duct 101, in a turbulent regime, further increasing the heat exchange between the active medium 2 and the cooling liquid 6. Consequently, the use of a cooling liquid 6, in accordance with the invention, that is, operating at a temperature that limits the thermo-optical coefficient of the cooling liquid 6 so as to comply with condition C1, makes it possible, despite the turbulence and instabilities associated with the flow of the cooling liquid 6, to maintain a good quality amplified laser beam 82 when the laser beam 80 and/or the amplified laser beam 82 passes through the cooling liquid 6. In addition, the cooling liquid 6 is in physical contact with at least one plate of the active medium 2. This proximity has the advantage of simplifying the architecture of the laser amplifier head 1 and the cooling circuit 100 without impacting the incident laser beam 80 and/or the amplified laser beam 82.

Heat exchange between the active medium 2 and the cooling liquid 6, which has a low thermo-optical coefficient, by working on the temperature of the cooling liquid 6, is designed to improve thermal extraction from the laser amplifier head 1 without degrading the optical quality of the incident laser beam 80 or the amplified laser beam 82 passing through the cooling liquid 6. Indeed, the use of a cooling liquid 6 with a low thermo-optical coefficient, which satisfies condition C1, for a cooling liquid temperature that is relatively low compared with the temperature of the active medium 2, has the advantage of increasing the cooling capacity of the liquid without degrading the profile of the amplified laser beam 82.

Preferentially, the means 102 of regulating the temperature of the cooling liquid 6 is able to cancel out, that is make zero, the thermo-optical coefficient

$$\vert \frac{dn}{dT} \vert$$

of the cooling liquid 6, thus limiting any optical deformation of the incident laser beam 80 during the thermal extraction of calories from the active medium 2. In practice, the regulating means 102 regulates the temperature of the cooling liquid 6 within a range around the temperature value which cancels out the thermo-optical coefficient

$$\vert \frac{dn}{dT} \vert .$$

By way of example, for heavy water D₂O, the regulating means 102 regulates the heavy water temperature at around 8° C., which is the temperature that cancels out the thermo-optical coefficient

$$\vert \frac{dn}{dT} \vert$$

of the heavy water D₂O. If standard water is used as a cooling liquid, the regulating means 102 regulates the temperature of the standard water in the immediate vicinity of 0° C.

As an indication, the cooling means 10 according to the invention increases the heat exchange between the active medium 2 and the cooling liquid 6 by a factor of between three and five compared with a cooling configuration of the prior art presented above.

The cooling liquid 6 is:
a liquid transparent to the wavelength of the laser beam, namely 1030 nm, and to the wavelength of the auxiliary optical pumping laser(s),
a liquid whose temperature minimizes the thermo-optical coefficient of this cooling liquid within a range compatible with the operation of the laser amplifier head 1
a liquid with thermal properties that make it a good heat transfer medium.

The cooling liquid 6 is, for example, water. In fact, water has the advantage of respecting the above-mentioned cooling liquid conditions, since the thermo-optical coefficient of water cancels out when the temperature thereof is close to 0° C. Alternatively, the cooling liquid 6 is heavy water, D₂O, which is less absorbent than ordinary water (H₂O) at the wavelength of the auxiliary optical pumping laser(s), which may be 940 nm or 970 nm, and at the wavelength of Yb:YAG (1030 nm). Alternatively, the cooling liquid 6 is oil or a solvent. Consequently, as previously stated, the cooling liquid 6 enters the housing via an inlet port 40 at a target temperature, flows towards the at least one plate of the active medium 2, exchanges heat with the at least one plate of the active medium 2 by circulating along the at least one plate, before being discharged via the outlet port 42 having been heated by the active medium 2. In another preferential alternative, the cooling liquid 6 is deionized water, obtained by distillation, free of any minerals. The use of deionized water has the advantage of preventing clogging inside the laser amplifier head 1, and damaging the optical surfaces of the crystals. As a result, the means 102 of regulating the temperature of the cooling liquid 6 is able to regulate the temperature of the cooling liquid 6, namely water, between 0° C. and 10° C., 10° C. being the water temperature limit for which condition C1 is met.

In another embodiment, it may also be possible to mix different cooling liquids 6 so as to influence the temperature value that cancels out the thermo-optical coefficient

$$\vert \frac{dn}{dT} \vert$$

of this cooling liquid mixture. Consequently, the cooling liquid 6 is a mixture of at least two chemical substances and has a thermo-optical coefficient different from that of each of these at least two substances. By way of example, the cooling liquid mixture may comprise a volume of water equivalent to 90% of the volume of the cooling liquid mixture and a volume of heavy water equivalent to 10% of the volume of the cooling liquid mixture. As a result, the temperature of the cooling liquid mixture allowing the thermo-optical coefficient thereof to be canceled is increased by around 0.8° C., which has the advantage of moving away from the solidification temperature of the cooling liquid mixture. The cooling liquid mixture may also comprise organic solvents equivalent to between 1% and 5% of the volume of the cooling liquid mixture.

Preferably and in order to limit the local optical path variation Δn*L, the means 102 of regulating the temperature of the cooling liquid 6 regulates the temperature of the cooling liquid 6 such that the thermo-optical coefficient

$$\frac{dn}{dT}$$

of the cooling liquid 6 satisfies the following condition:

$$\vert \frac{dn}{dT} \vert < \frac{3 {λ}_{0}}{Δ T * \sum {φ}_{H}} ( C 2 )$$

Indeed, condition C2 then enables the temperature of the cooling liquid 6, namely water, to be regulated between 0° C. and 5° C., and the difference in temperature ΔT between the cooling liquid 6 and the at least one plate of an active medium 2 to be increased (between 15° C. and 20° C.) for a hydraulic diameter φ_{H} of the at least one cooling duct 101 for the cooling liquid 6 equal to 3 millimeters passed through twice and for a wavelength λ₀ of the laser beam 80 in the vacuum of 1030 nm, while ensuring a thermo-optical coefficient

$$\frac{dn}{dT}$$

of the cooling liquid 6 equal to 30e-6, that is, equivalent to 0, thus reflecting the negligible impact of the cooling liquid 6 on the incident laser beam 80 and on the amplified laser beam 82 passing therethrough.

According to an ideal embodiment, the alpha factor is equal to 1.5 so as to generate a condition C3 for optimizing the regulation of the thermo-optical coefficient

$$\frac{dn}{dT}$$

of the cooling liquid 6:

$$\vert \frac{dn}{dT} \vert < \frac{1.5 {λ}_{0}}{Δ T * \sum {φ}_{H}} ( C 3 )$$

Additionally, the optimum working temperature of the cooling liquid 6, namely water, or the temperature at which the water allows optimum extraction of heat from the active medium 2, is close to the solidification point of water. Consequently, the use of a coil in the cooling circuit 100, as is customary, generates ice which envelops the coil and hinders the cooling of the water.

Thus, advantageously, the cooling means 10 comprise a storage device 105 for the cooling liquid 6. By way of example, the storage device 105 is a water storage tank. Furthermore, the cooling liquid 6 is partly liquid and partly solid, so that it is in equilibrium between its liquid and solid phases. In other words, water in the form of ice can be observed in the storage device 105 in addition to water in liquid form. A heterogeneous mixture of iced water and water in liquid form thus has the advantage of keeping the temperature of the cooling liquid 6, namely water, very low. By way of example, a water storage tank comprising a heterogeneous mixture of iced water and water in liquid form maintained at a temperature of around 0.2° C. ensures a cooling liquid temperature in the cooling circuit 100 of around 1° C., optimizing heat exchange in the housing 4.

In order to be able to circulate only water in liquid form in the cooling circuit 100, the cooling means 10 comprises a pumping device 106 for the cooling liquid 6 able to draw up the liquid phase of the cooling liquid 6, namely water in liquid form, from the storage device 105. Additionally, the means 104 of regulating the flow rate of the cooling liquid 6 and the pumping device 106 of the cooling liquid 6 can be combined, for example in the case of an adjustable hydraulic pump.

The laser amplifier head 1 also comprises a physico-chemical filtering and biological purification system 108 for the cooling liquid 6. The physico-chemical filtering and biological purification system 108 is configured to eliminate biological micro-organisms, in particular algae, which can foul the inside of the laser amplifier head 1 and damage the optical surfaces of the crystals. The physico-chemical filtering and biological purification system 108 is, for example, a nanoparticle filtration device, part of which is conventional in principle, wherein the cooling liquid 6 passes through filter volumes. The physico-chemical filtering and biological purification system 108 removes all physical nanoparticles, either from dust in the ambient air, or from the detachment of surface elements at any point in the laser amplifier head 1 or in the cooling circuit 100, or from deposits of electrochemical origin, if the cooling circuit 100 comprises different metals, inducing an oxidation-reduction phenomenon. In addition, the physico-chemical filtering and biological purification system 108 prevents the development of micro-organism growth, for example by adding additives to the cooling liquid 6.

FIG. 2 shows a second schematic embodiment of the laser amplifier head 1 comprising a system 12 for checking the spatial quality of the amplified laser light. The checking system 12 comprises an unlimited number of optical sensors (CCD1, CCD2, etc.). A first optical sensor CCD1 is aligned with a first lens L1 which receives the amplified laser beam 82 along a first optical path CO1. In addition, the optical distance between the first lens L1 and the housing 4 is selected so as to generate, on the first optical sensor CCD1, a so-called “near-field” display, which provides an image to the first optical sensor CCD1 of any effects of turbulence at the surface of the first lens L1. A second optical sensor CCD2 is aligned with a second lens L2 which receives the amplified laser beam 82 along a second optical path CO2 distinct from the first optical path CO1. Additionally, the optical distance between the second lens L2 and the housing 4 is selected so as to generate an infinity profile of the amplified laser beam (“far field”) on the second optical sensor CCD2. Any optical effect of turbulence in the cooling liquid 6 is visible by strioscopic imaging on the plane of the first optical sensor CCD1, and results in the appearance of new light rays at the focus of the second lens L2, imaged by the optical sensor CCD2. Quantitative evaluation of the energy dispersed far from the focal spot, at the focal point, makes it possible to qualify the impact of turbulence linked to the cooling liquid 6 on the amplification of the incident beam 80 by the laser amplifier head 1.

In addition, the cooling system 10 comprises sensors (110, 111, 112, 113) positioned along the cooling circuit 100 so as to measure the flow rate and/or temperature of the cooling liquid 6 circulating in the cooling circuit 100 and to deduce the Reynolds number thereof in the at least one duct 101 of the housing 4. More specifically, the sensors (110, 111, 112) directly measure the temperature of the cooling liquid 6. The sensors (110, 111, 112) thus allow the kinematic viscosity of the cooling liquid 6 to be estimated at any point in the cooling circuit. The sensor 113 allows the flow rate of the cooling liquid 6 to be measured; all of these measurements are used to obtain the value of the Reynolds parameter at any point in the cooling circuit 100 and the housing 4, in particular in the at least one cooling duct 101. By way of example, the cooling means 10 comprises:
a first sensor 110 placed in the storage device 105 to measure the temperature of the cooling liquid 6,
a second sensor 111 placed near the inlet port 40 of the housing to measure the temperature of the cooling liquid 6 prior to extraction of the heat generated by the active medium 2,
a third sensor 112 placed close to the outlet port 42 of the housing 4 to measure the temperature of the cooling liquid 6 after extraction of the heat produced by the active medium 2,
a fourth sensor 113 placed in series with the flow rate control means 104, to measure the flow rate of the cooling liquid 6.

The sensors 111 and 113 allow the Reynolds number to be measured at the inlet of the at least one cooling duct 101, and the sensors 112 and 113 allow the Reynolds number to be measured at the outlet of the at least one cooling duct 101. All of the sensors (110, 111, 112, 113) can thus be used to measure the Reynolds number of the cooling liquid 6 and to control the flow rate of the cooling liquid 6, for example by the means 104 of regulating the flow rate of the cooling liquid 6 or by a control loop.

All of the sensors 110, 111, 112 ensure that the working temperature of the cooling liquid, that is the temperature at which the cooling liquid 6 begins heat extraction in the housing 4, does not exceed a thermo-optical coefficient value of the cooling liquid that could impact the amplified laser beam 82 from the beginning to the end of the path of the cooling liquid 6 in the housing 4.

In one embodiment, the laser amplifier head 1 comprises a contact opening 411, one face of the contact opening 411 rests against the housing 4, a hygroscopic insulating volume 43 and an eccentric opening 412. The contact opening 411, the hygroscopic insulating volume 43 and an eccentric opening 412 are successively aligned parallel to the incident laser beam 80 and the amplified laser beam 82, so that the incident laser beam 80 successively passes through an eccentric opening 412, a hygroscopic insulating volume 43 and a contact opening 411 before passing through the housing 4, and so that the laser beam 82 amplified by the active medium 2, upon exiting the housing 4, successively passes through a contact opening 411, a hygroscopic insulating volume 43 and an eccentric opening 412. The hygroscopic insulating volume 43 of the openings 41 prevents condensation on the openings 41 due to the temperature differential that can be observed between the cooling liquid 6 and the environment of the laser amplifier head 1. The hygroscopic insulating volume 43 takes the form of a chamber, isolated from the contact opening 411 and the eccentric opening 43, filled with air at ambient pressure. In addition, the hygroscopic insulating volume 43 can comprise a desiccant sachet to absorb the ambient humidity.

In fact, condensation occurs firstly because the cooling temperature of the cooling liquid 6, satisfying one of conditions C1, C2 or C3, is then below the so-called “dew point” temperature. Through contact, the contact openings 411 and eccentric openings 412 are brought to the temperature of the cooling liquid 6, and therefore below the dew point, giving rise to condensation. The use of the hygroscopic insulating volume 43 thus means that this criterion for selecting the cooling liquid temperature that respects the dew point can be avoided.

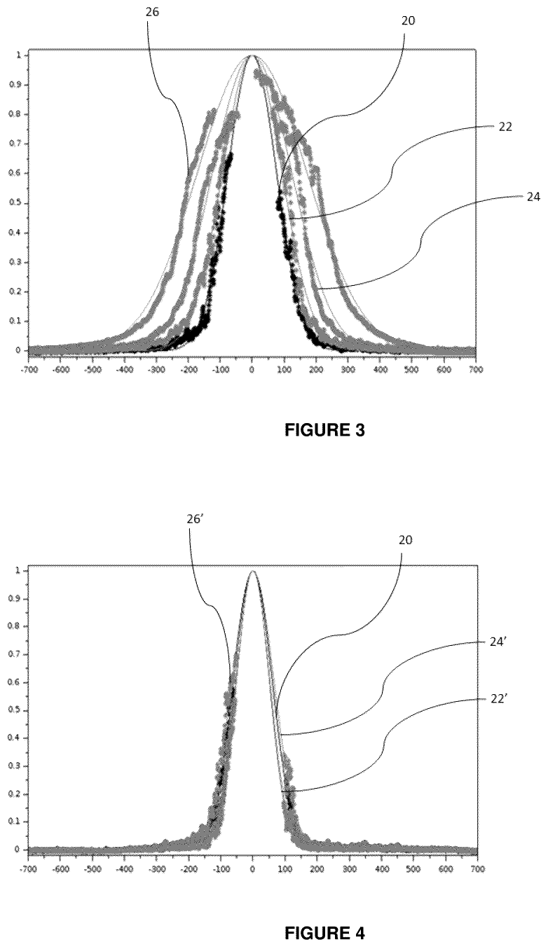

FIG. 3 shows a graph of the spatial frequency distribution for a far-field profile of an amplifier head according to the prior art cooled by a cooling liquid, namely water, at a temperature of 20° C. Turbulence of various kinds appearing in the cooling liquid under thermal load results in fluctuations in the wavefront of the amplified laser beam 82. These fluctuations lead to the appearance of new spatial frequencies in the “far field”.

FIG. 3 should be compared with FIG. 4, which shows the same graph of the width of the spatial frequency distribution for a far-field profile of the amplifier head cooled by cooling liquid 6 to a temperature of around 1° C. according to the invention.

FIGS. 3 and 4 show a reference curve 20 representing the width of the spatial frequency distribution with no thermal load on the active medium 2. The curves 22, 24 and 26 show the spatial frequencies for increasing cooling liquid flows of 1, 5 and 12 liters per minute respectively. It is therefore possible to observe on FIG. 3 an increasing widening of the spatial frequency distributions between curves 22, 24 and 26 due to the increasing presence, based on the cooling liquid flow selected, of turbulence for the prior art. Conversely, this widening of curves 22′, 24′ and 26′, respectively showing the spatial frequencies for increasing cooling liquid flows of 1, 5 and 12 liters per minute, is very limited to such an extent that curves 22′, 24′ and 26′ are superimposed on the reference curve 20, reflecting optimal operation in terms of temperatures without attenuating the quality of the amplified laser beam.

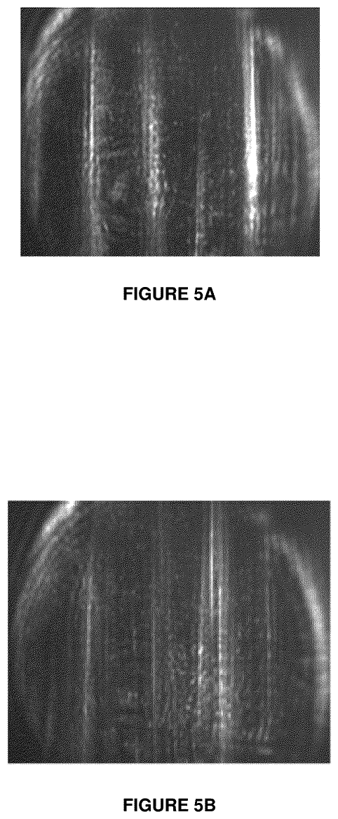

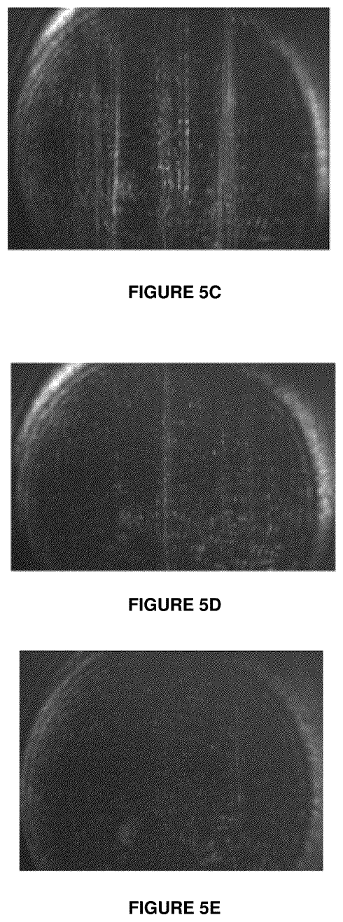

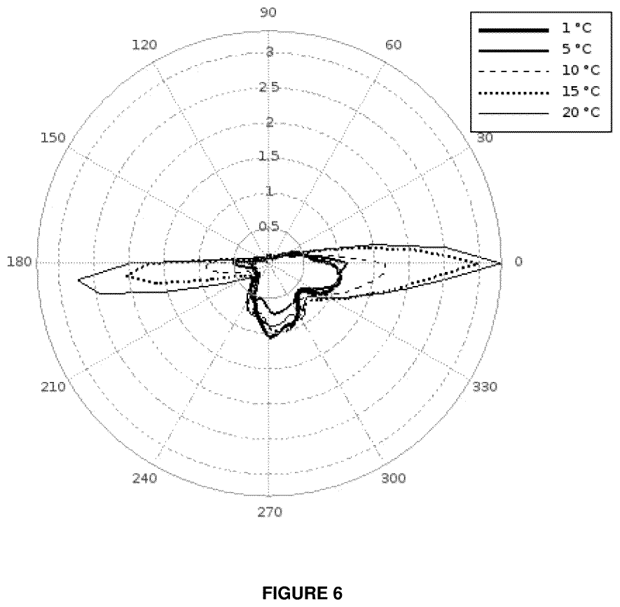

FIGS. 5A, 5B, 5C, 5D and 5E are images acquired by an optical sensor of an amplified laser beam after having passed through a cooling liquid, namely water, in the turbulent regime, for an actively maintained Reynolds number equal to 4600, at a temperature of 20° C. for FIG. 5A, at a temperature of 15° C. for FIG. 5B, at a temperature of 10° C. for FIG. 5C, at a temperature of 5° C. for FIG. 5A and at a temperature of 1° C. for FIG. 5E. In addition, the temperature difference ΔT between the surface temperature of the at least one plate of the active medium 2 and the water temperature is maintained at 17° C. FIG. 5A shows the presence of vertical striations in the direction of flow of the cooling liquid, resulting from hydrodynamic instabilities in the flow of the cooling liquid. At 20° C., the thermo-optical coefficient of water is non-negligible and hydrodynamic instabilities generate significant local fluctuations in the optical index, resulting in scattering of the laser beam. Conversely, at 1° C., as previously stated, the thermo-optical coefficient of water is negligible, resulting in the absence of vertical striations on FIG. 6. As a result, the impact of turbulence in the cooling liquid is negligible and the amplification capabilities of ytterbium:YAG on the incident laser beam 80 are significantly improved by around 5% to 10%. FIGS. 5B, 5C and 5D show the gradual disappearance of vertical striations as the temperature approaches the optimum, namely 0° C. for water. Consequently, as turbulence is identical in scenarios 5A to 5E, only the footprint thereof on the beam varies.

FIG. 6 is a polar diagram showing the ratio C between the energy scattered out of the amplified laser beam 82, and the energy remaining in the beam, based on an azimuthal angle θ for different cooling liquid temperatures. The angle θ is defined in a plane perpendicular to the propagation axis of the amplified laser beam 82, and 270° corresponds to the direction of flow of the cooling liquid in the housing 4. The ratio C for an angle θ is calculated on far-field imaging as the ratio between the energy in the spatial “pedestal” of the amplified laser beam and the energy contained in the Gaussian central spot, for a differential angular sector centered on the direction characterized by the angle θ. It can be seen that, as we move away from the optimum temperature of 0° C., the pedestal of the amplified laser beam 82 widens in a direction perpendicular to the flow of the cooling liquid. The effect of diffraction of the amplified laser beam 82 by the striations of turbulence visible in the near-field, shown in FIG. 5A for example, can be seen here.

The invention therefore aims to improve the thermal extraction of high-power laser amplifier heads by using a transparent fluid, namely the cooling liquid, in a turbulent regime through which the laser beam to be amplified passes. The laser beam to be amplified maintains a very acceptable optical quality as it passes through the transparent fluid, by stabilizing the fluid temperature in a range where the thermo-optical index thereof is close to zero.

1-12. (canceled)

13. A laser amplifier head comprising at least one plate of a solid-state laser active medium which is placed inside a housing which has an inlet port and an outlet port for a cooling liquid, as well as at least one window that allows a laser beam to be amplified to pass through the plate or plates of laser active medium, characterized in that it also comprises:
a cooling means for the active medium, the cooling means comprising a cooling circuit connected to the housing via the inlet port and the outlet port, the cooling circuit being suited to the circulation of a cooling liquid in turbulent regime, the cooling means comprising at least one cooling duct inside the housing, connecting the inlet port and the outlet port, and in contact with the active medium, wherein the cooling liquid flows so as to allow an exchange of heat between the active medium and the cooling liquid, the cooling means also comprising a regulating means of the cooling liquid temperature able to regulate a temperature of the cooling liquid such that a thermo-optical coefficient
$$\frac{dn}{dT}$$
of the cooling liquid satisfies the following condition:
$$\vert \frac{dn}{dT} \vert < \frac{6 {λ}_{0}}{Δ T * \sum {φ}_{H}}$$
and preferably
$$\vert \frac{dn}{dT} \vert < \frac{3 {λ}_{0}}{Δ T * \sum {φ}_{H}}$$
where ΔT represents the difference in temperature between the cooling liquid and the at least one active medium plate, Σφ_{H} represents the sum of the hydraulic diameters of the cooling ducts through which the laser beam passes and λ₀ represents the wavelength of the laser beam in a vacuum.

14. The laser amplifier head according to claim 13, wherein the means of regulating the temperature of the cooling liquid is able to cancel the thermo-optical coefficient of the cooling liquid.

15. The laser amplifier head according to claim 13, wherein the cooling means comprises a means of regulating the flow rate of the cooling liquid able to regulate a Reynolds number of the cooling liquid so as to be greater than 2300.

16. The laser amplifier head according to claim 13, wherein the cooling liquid is water.

17. The laser amplifier head according to claim 13, wherein the cooling liquid is a mixture of at least two chemical substances and has a thermo-optical coefficient different from that of each of these at least two substances.

18. The laser amplifier head according to claim 16, wherein the means of regulating the temperature of the cooling liquid is able to regulate the temperature of the cooling liquid between 0° C. and 10° C.

19. The laser amplifier head according to claim 18, wherein the cooling means comprises:
a storage device for the cooling liquid, said cooling liquid being in equilibrium between its liquid and solid phases,
a pumping device for the cooling liquid able to draw up the liquid phase of the cooling liquid from the storage device.

20. The laser amplifier head according to claim 13, wherein the cooling liquid is in contact with one of the plurality of active medium plates.

21. The laser amplifier head according to claim 13, further comprising a contact opening, a hygroscopic insulating volume and an eccentric opening, the contact opening having a face bearing against the housing, the contact opening, the hygroscopic insulating volume and the eccentric opening being successively aligned along the laser flow.

22. The laser amplifier head according to claim 13, further comprising at least one sensor positioned along the cooling circuit so as to measure the flow rate and/or temperature of the cooling liquid in order to deduce the Reynolds number of the cooling liquid in the at least one cooling duct of the housing.

23. The laser amplifier head according to claim 13, further comprising a physico-chemical filtering and biological purification system for the cooling liquid.

24. The laser amplifier head according to claim 13, further comprising a system for checking the spatial quality of an amplified laser beam at the outlet of the laser amplifier head.
